(19) United States
(12) Patent Application Publication
(10) Pub. No.: US 2008/0291384 A1
(43) Pub. Date: Nov. 27, 2008

(54) DISPLAY APPARATUS AND METHOD OF MANUFACTURING THE SAME

(75) Inventor: Hitoshi KOYAMA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/121,071

(22) Filed: May 15, 2008

(30) Foreign Application Priority Data
May 23, 2007 (JP) 2007-136415

(51) Int. Cl. G02F 1/1339

(52) U.S. Cl. 349/155; 349/187

(57) ABSTRACT

A display apparatus includes a counter substrate, an array substrate placed opposite the counter substrate, a liquid crystal sandwiched between the counter substrate and the array substrate, and a columnar spacer placed on a surface of the counter substrate facing the array substrate so as to maintain a gap between the counter substrate and the array substrate. A step portion with a height of 0.3 μm or smaller is placed on the part of the array substrate which is opposite the columnar spacer or on the top face of the columnar spacer, and the proportion of a highest level of the step portion to the top face of the columnar spacer is ½ or smaller.

### BACKGROUND OF THE INVENTION

1. Field of the Invention

The present invention relates to a display apparatus and a method of manufacturing the same.

2. Description of Related Art

A liquid crystal display apparatus generally has a structure in which a pair of substrates are attached one another by a sealing material that is formed at the outer edge of an image display portion and liquid crystal is sealed in the space between the substrates. As a method of accurately controlling the gap between the substrates (panel gap), a technique of placing columnar spacers on one substrate is known.

If the density of columnar spacers placed in a panel of a liquid crystal display apparatus is low, the columnar spacers are likely to be deformed by an external force which is applied to the panel. This causes a change in the panel gap, which leads to display unevenness. On the other hand, if the density of columnar spacers is high, the panel gap cannot follow the volume shrinkage of liquid crystal under the low temperature environment. This causes the phenomenon called low-temperature bubbling, that is bubbling of liquid crystal due to a decrease in the pressure inside the panel.

In Japanese Unexamined Patent Application Publication No. 2002-341354, a technique of placing two kinds of columnar spacers with different heights is disclosed (related art 1). FIG. 12 is a sectional view of a liquid crystal display apparatus according to the related art 1. Referring to FIG. 12, an array substrate 110 and a color filter substrate 120 are placed opposite each other. Liquid crystal 130 is sandwiched between the two substrates.

In the array substrate 110, a pattern layer 112 is disposed on a substrate 111. In the pattern layer 112, a pixel electrode, a scanning signal line and a video signal line which form a display area are placed with an insulating layer respectively interposed therebetween. In the color filter substrate 120, a colored layer 123 is disposed on a substrate 121. A transparent counter electrode 124 such as ITO is disposed on the colored layer 123. Further, a first columnar spacer 125 and a second columnar spacer 126 having different heights are disposed on the counter electrode 124.

The first columnar spacer 125 determines a panel gap with the opposite array substrate 110. The second columnar spacer 126 is lower than the first columnar spacer 125 and does not normally maintain the panel gap with the array substrate 110. If a strong external force is applied to the panel and the first columnar spacer 125 is deformed, the second columnar spacer 126 contributes to maintain the panel gap with the array substrate 110. On the surfaces of the array substrate 110 and the color filter substrate 120 which face each other, alignment layers 119 and 129 are disposed, respectively.

Further, in Japanese Unexamined Patent Application Publication No. 2002-341354, a technique of placing columnar spacers with the same height in the positions opposite two areas with different total film thicknesses is disclosed (related art 2). FIG. 13 is a sectional view of a liquid crystal display apparatus according to the related art 2. Referring to FIG. 13, in the array substrate 110 of the related art 2, a step portion 113 is placed within the pattern layer 112. In the step portion 113, the pattern layer 112 having a large film thickness is formed. Further, in the color filter substrate 120, a first columnar spacer 127 and a second columnar spacer 128 having the same thickness are placed.

The first columnar spacer 127 is placed in the part which is opposite the step portion 113. Thus, the panel gap is determined by the first columnar spacer 127 which is opposite the step portion 113. The second columnar spacer 128 is placed in the part which is opposite an area where the step portion 113 is not placed and does not normally maintain the panel gap with the array substrate 110. If a strong external force is applied to the panel and the first columnar spacer 127 is deformed, the second columnar spacer 128 contributes to maintain the panel gap with the array substrate 110.

As described above, according to the related arts 1 and 2, the first columnar spacer 125 or 127 maintains the panel gap in the normal state. When a strong external force is applied, the second columnar spacer 126 or 128, in addition to the first columnar spacer 125 or 127, contributes to maintain the panel gap. It is thereby possible to prevent a further change in the panel gap, thereby suppressing display unevenness.

However, the techniques of the related arts 1 and 2 need to place about double the number of columnar spacers. This causes a decrease in yield in the process such as the formation of columnar spaces and rubbing.

Further, in order to avoid the low-temperature bubbling, the first columnar spacer 125 or 127 which normally serves to maintain the gap is preferably 10 μm or smaller in diameter. Although the first columnar spacer 125 or 127 is not likely to be deformed as the diameter increases, the following issues occur at the same time. Specifically, the thin first columnar spacer 125 or 127 with the diameter of 10 μm or smaller has a low adhesion strength. Further, the thin first columnar spacer 125 or 127 with the diameter of 10 μm or smaller is likely to have an inverted triangle shape with its bottom face smaller than its top face. Thus, the possibility that the first columnar spacer 125 or 127 falls off during the process of rubbing or cleaning is high. If a large number of first columnar spacers 125 or 127 fall off, point defect or gap defect occurs, for example. As a result, the display quality of the liquid crystal display apparatus is deteriorated, and a yield decreases accordingly.

In view of the foregoing, it is an object of the present invention to provide a display apparatus which suppresses a decrease in yield and has a high display quality and a method of manufacturing the same.

### SUMMARY OF THE INVENTION

According to an embodiment of the present invention, there is provided a display apparatus which includes a first substrate, a second substrate that is placed opposite the first substrate, a display material that is placed between the first substrate and the second substrate, a columnar spacer that is placed above a surface of the first substrate which faces the second substrate so as to maintain a gap between the first substrate and the second substrate, and a step portion placed above a part of the second substrate that is opposite the columnar spacer or on a top face of the columnar spacer with a height of 0.3 μm or smaller with a proportion of a highest level of the step portion to the top face of the columnar spacer being ½ or smaller.

The present invention provides a display apparatus which suppresses a decrease in yield and has a high display quality and a method of manufacturing the same.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a sectional view of a liquid crystal display apparatus according to an embodiment of the present invention;

FIG. 2 is a schematic sectional view showing a columnar spacer and its vicinity according to a first embodiment in an enlarged scale;

FIG. 3 is a top view schematically showing an array substrate in FIG. 2;

FIG. 4 is a schematic sectional view showing a columnar spacer and its vicinity according to a second embodiment in an enlarged scale;

FIG. 5 is a top view schematically showing an array substrate in FIG. 4;

FIG. 6 is a schematic sectional view showing a columnar spacer and its vicinity according to a third embodiment in an enlarged scale;

FIG. 7 is a top view schematically showing an array substrate in FIG. 6;

FIG. 8 is a schematic sectional view showing a columnar spacer and its vicinity according to a fourth embodiment in an enlarged scale;

FIG. 9 is a top view schematically showing an array substrate in FIG. 8;

FIG. 10 is a schematic sectional view showing a columnar spacer and its vicinity according to a fifth embodiment in an enlarged scale;

FIG. 11 is a top view schematically showing an array substrate in FIG. 10;

FIG. 12 is a sectional view of a liquid crystal display apparatus according to a related art 1; and

FIG. 13 is a sectional view of a liquid crystal display apparatus according to a related art 2.

### DESCRIPTION OF THE PREFERRED EMBODIMENTS

### First Embodiment

A display apparatus according to an embodiment of the present invention is described hereinafter with reference to FIG. 1. FIG. 1 is a sectional view of a liquid crystal display apparatus according to an embodiment of the present invention. Although the display apparatus of this embodiment is described taking an active matrix liquid crystal display apparatus which includes a thin film transistor (TFT) as an example, a switching device may be different from a TFT. Further, a display apparatus may be a passive matrix liquid crystal display apparatus. The present invention is not limited to a liquid crystal display apparatus, and it is applicable to any display apparatus in which a display material such as liquid crystal, particle or liquid is placed between an array substrate and a counter substrate.

Referring to FIG. 1, in a liquid crystal display apparatus according to this embodiment, an array substrate 10 and a counter substrate 20 are placed opposite each other. Liquid crystal 30 is sealed in the space surrounded by the two substrates and a sealing material 34 which attaches the substrates together. The sealing material 34 has a frame shape which surrounds a display area of the liquid crystal display apparatus.

In the array substrate 10, a pixel electrode 16, a scanning signal line (not shown) and a video signal line (not shown) which form the display area are disposed above a substrate 11 with an insulating layer 15 respectively interposed therebetween. A plurality of scanning signal lines (gate lines) are arranged in parallel with each other. A plurality of video signal lines (source lines) are also arranged in parallel with each other. Each scanning signal line and each video signal line intersect with each other. An area which is surrounded by adjacent scanning signal lines and video signal lines is a pixel. Thus, pixels are arranged in matrix in the display area. The pixel electrode 16 is placed substantially all over the pixel.

In the vicinity of the point of intersection between each scanning signal line and each video signal line, a TFT 14, which is a switching device, is placed. The TFTs 14 are arranged in an array in the display area. Each TFT 14 includes a drain electrode and a source electrode which are formed in the same layer as the video signal line. The source electrode and the drain electrode are connected through a semiconductor layer. The video signal line and the pixel electrode 16 are connected through the TFT 14. When the TFT 14 is turned on by a scanning signal, a display signal is supplied to the pixel electrode 16 through the video signal line. In this embodiment, a bottom gate TFT 14 may be used, for example.

On the pixel electrode 16, an alignment layer 19 for aligning liquid crystal 30 is disposed. Thus, the alignment layer 19 for aligning liquid crystal 30 is placed on the surface of the array substrate 10 which is in contact with liquid crystal 30. On the outer surface of the substrate 11, a polarizing plate 31 is adhered. Further, on the array substrate 10, a terminal 37 for receiving an external signal to be supplied to the TFT 14 is disposed.

In the counter substrate 20, a light shielding layer 22 for shielding light, which is made of pigment or a metal such as chromium, is disposed on the surface of a substrate 21 which faces the array substrate 10. Further, a colored layer 23, which is made of pigment or dye, is disposed to fill the space between the light shielding layer 22. The colored layer 23 may be a color filter of red (R), green (G) and blue (B), for example. Furthermore, a counter electrode 24 is formed substantially all over the display area so as to cover the light shielding layer 22 and the colored layer 23. The counter electrode 24 generates an electric field between the pixel electrode 16 of the array substrate 10 and the counter electrode 24 and thereby drives liquid crystal 30.

On the counter electrode 24, a columnar spacer (not shown) is placed. The columnar spacer is a column-shaped projection which uniformly maintains the panel gap between the array substrate 10 and the counter substrate 20. In the display area, a plurality of columnar spacers are arranged at predetermined intervals. The shape and the position of the columnar spacers are characteristic in the embodiments of the present invention, and the details are described later. Further, an alignment layer 29 is disposed to cover the counter electrode 24 and the columnar spacers. On the outer surface of the substrate 21, a polarizing plate 32 is adhered.

The array substrate 10 and the counter substrate 20 are attached through the sealing material 34. A transparent insulating substrate such as a glass substrate or a quartz glass may be used as the substrates 11 and 21. The sealing material 34 may be a photo-curing or thermosetting acrylic resin or epoxy resin, or an ultraviolet curing resin. The liquid crystal display apparatus of this embodiment further includes a control board 35 for generating a driving signal, a flexible flat cable (FFC) 36 for electrically connecting the control board 35 to the terminal 37, a backlight unit (not shown) which serves as a light source and so on.

In such a liquid crystal display apparatus, when an electric signal is input from the control board 35, a driving voltage is applied to the pixel electrode 16 and the counter electrode 24. The orientation of the molecule of liquid crystal 30 changes according to the driving voltage. The light which is emitted from the backlight unit is transmitted to the outside or blocked through the array substrate 10, liquid crystal 30 and the counter substrate 20, and thereby an image or the like is displayed on the liquid crystal display apparatus. Hence, a desired image can be displayed by changing the driving voltage for each pixel.

The operating mode of the liquid crystal display apparatus may be twisted nematic (TN) mode, super twisted nematic (STN) mode, ferroelectric liquid crystal mode or the like. Further, a display apparatus may be an in-plane switching liquid crystal display apparatus in which the counter electrode 24, which is placed in the counter substrate 20 in the above example, is placed in the array substrate 10 so that an electric field is applied to the liquid crystal 30 horizontally between the pixel electrode 16 and the counter electrode 24.

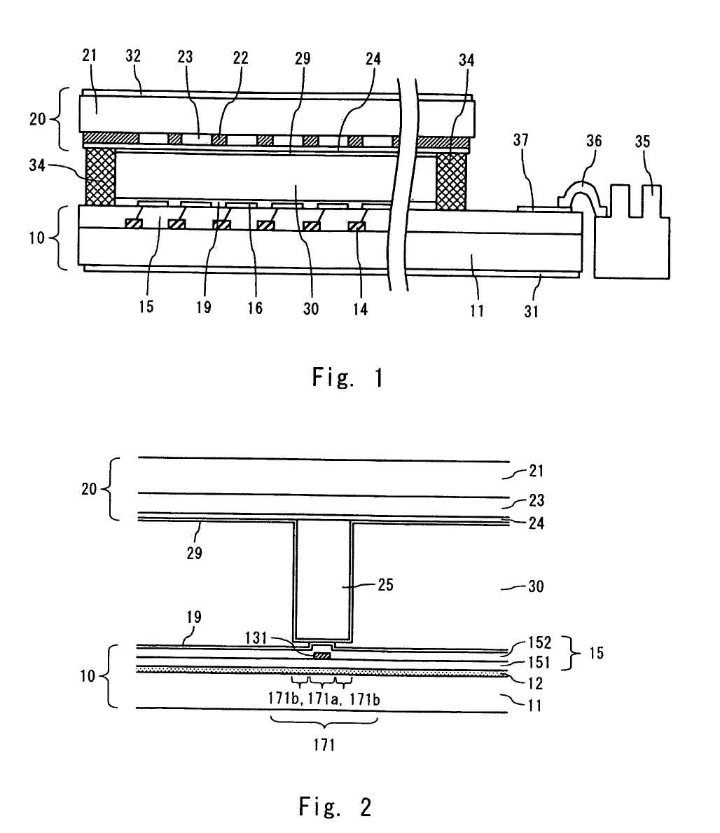

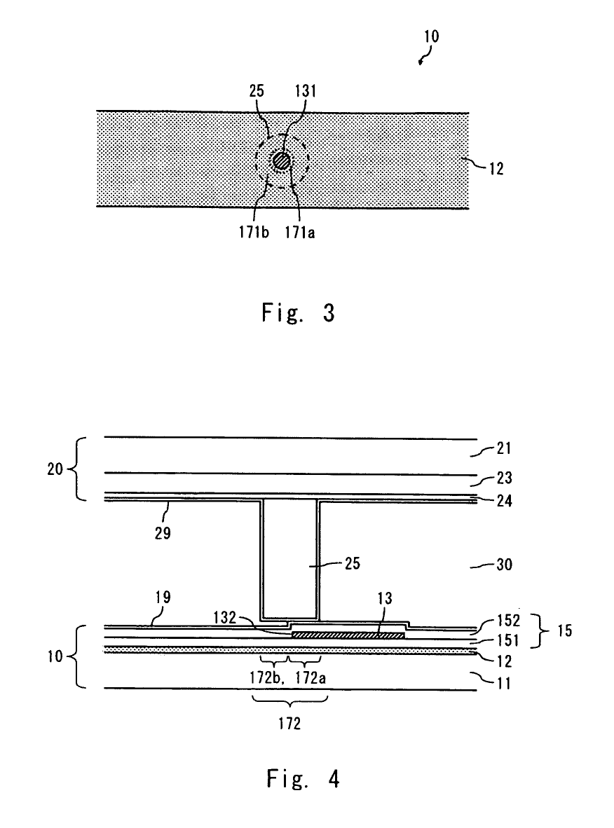

The columnar spacer according to the embodiment is described hereinafter in detail with reference to FIGS. 2 and 3. FIG. 2 is a schematic sectional view showing a columnar spacer and its vicinity according to a first embodiment of the present invention in an enlarged scale. FIG. 3 is a top view schematically showing the array substrate 10 in FIG. 2. In FIG. 3, the outer shape of the columnar spacer which is placed on the counter substrate 20 is illustrated by a dotted line for convenience of description. In FIGS. 2 and 3, a scanning signal line 12 is placed below a video signal line in the array substrate 10 by way of illustration.

Referring to FIG. 2, the array substrate 10 and the counter substrate 20 are placed opposite each other like in FIG. 1. Liquid crystal 30 is sandwiched between the two substrates. In the counter substrate 20, the colored layer 23 is disposed on the substrate 21. The transparent counter electrode 24 such as ITO is disposed on the colored layer 23. Further, a columnar spacer 25 is placed on the counter electrode 24. The columnar spacer 25 has a column shape. Although the shape of the columnar spacer 25 may be a square pole, a circular cone trapezoid, a square cone trapezoid or the like, a column-shaped spacer 25 is used in this example.

In the array substrate 10, the scanning signal line 12 is placed on the substrate 11. Further, an insulating layer 151 is disposed all over the substrate 11 so as to cover the scanning signal line 12. The insulating layer 151 may be a gate insulating layer, for example. On the insulating layer 151, the video signal line is placed in a part which is not shown. The video signal line is placed to intersect with the scanning signal line 12 with the insulating layer 151 interposed therebetween in a part which is not shown. In this embodiment, an island-shaped separated pattern 131, which is formed in the same layer as the video signal line, is placed above the scanning signal line 12. The separated pattern 131 is spaced from the video signal line, and it has a circular shape as shown in FIG. 3, for example. The shape of the separated pattern 131, however, is not limited thereto.

The separated pattern 131 is placed in the position opposite the columnar spacer 25. Specifically, referring to the top view of FIG. 3, the separated pattern 131 is placed in the area inside the side face of the columnar spacer 25. Thus, the separated pattern 131 is placed inside, without lying off, the opposite face (top face) of the columnar spacer 25 which faces the array substrate 10. It is preferred that the separated pattern 131 is disposed so as to include the center point of the top face of the columnar spacer 25. The area of the separated pattern 131 is set within the range that a protrusion 171a of a step portion 171, which is described later, is ½ or smaller the area of the top face of the columnar spacer 25.

On the separated pattern 131 and the video signal line, an insulating layer 152 is disposed all over the substrate 11. The insulating layer 152 may be an interlayer insulating film, for example. Further, the alignment layers 19 and 29 are disposed on the surfaces of the array substrate 10 and the counter substrate 20, respectively, which face liquid crystal 30. Although not shown in FIGS. 2 and 3, the pixel electrode 16 is placed between the alignment layer 19 and the insulating layer 152 as appropriate as shown in FIG. 1. The insulating layer 152 and the alignment layer 19 are placed to cover the separated pattern 131, thereby forming the step portion 171. The step portion 171 is composed of the protrusion 171a which is located above the separated pattern 131 and a base 171b which is located in the other area. Thus, in the part of the array substrate 10 which is opposite the columnar spacer 25, a total thickness of the array substrate 10 is larger in the protrusion 171a than in the base 171b, so that the protrusion 171a is highest in the part which is opposite the columnar spacer 25. The boundary between the protrusion 171a and the base 171b is a size larger than the separated pattern 131 as shown in FIG. 3.

Therefore, a part of the columnar spacer 25 is opposite the protrusion 171a of the step portion 171 and thereby determines the panel gap between the array substrate 10 and the counter substrate 20. On the other hand, the part of the columnar spacer 25 which is opposite the base 171b of the step portion 171 does not maintain the panel gap between the array substrate 10 and the counter substrate 20.

If an external force is applied to the panel, the part of the columnar spacer 25 which is opposite the protrusion 171a is elastically deformed to reduce the panel gap. If an external force which is applied to the panel becomes stronger, the space between the columnar spacer 25 and the array substrate 10 which is formed at the base 171b of the step portion 171 becomes gradually narrower. When an external force which is strong enough to eliminate the space is applied, the columnar spacer 25 which faces the base 171b contributes to maintain the gap. The gap is thereby maintained by substantially the entire top face of the columnar spacer 25, which prevents a further change in panel gap.

In the liquid crystal display apparatus, if a partial change in panel gap exceeds 0.3 μm, it is visually recognized as the display unevenness beyond an acceptable level. Therefore, the height of the step portion 171 which is placed in the part opposite the top face of the columnar spacer 25 is preferably larger than 0 μm and equal to or smaller than 0.3 μm. Thus, a difference in height between the protrusion 171a and the base 171b is 0.3 μm or smaller. In this example, the video signal line is formed by a thin film of 0.25 μm, and the step portion 171 has a height of 0.25 μm.

The area which is occupied by the protrusion 171a of the step portion 171 needs to be ½ or smaller the area of the top face of the columnar spacer 25. If the part of the top face of the columnar spacer 25 which is opposite the protrusion 171a is larger than the other part which is opposite the base 171b, the panel gap fails to follow the volume shrinkage of liquid crystal 30 under the low temperature environment. The pressure inside the panel thereby decreases, causing the bubbling of liquid crystal (low-temperature bubbling). Accordingly, the area of the separated pattern 131 is set within the range that the protrusion 171a with the area ½ or smaller the area of the top face of the columnar spacer 25 is formed. In this embodiment, the protrusion 171a is placed inside, without lying off, the top face of the columnar spacer 25. Preferably, the protrusion 171a is disposed so as to include the center point of the top face of the columnar spacer 25.

A method of manufacturing a liquid crystal display apparatus according to this embodiment is described hereinafter. Firstly, a plurality of electrodes such as the scanning signal line 12, the video signal line and the pixel electrode 16 are formed in this order above the substrate 11. The electrodes are patterned after performing the steps of known film formation, photolithography, etching and resist removal. Further, a semiconductor layer to form the TFT 14 is formed by photolithography. The insulating layer 15 is deposited all over the substrate 11 to fill between the electrodes. When forming the scanning signal line 12, the gate electrode of the TFT 14 is formed at the same time. Further, when forming the video signal line, the separated pattern 131 is formed at the same time. At this time, it is preferred to form the separated pattern 131 on the insulating layer 15 above the scanning signal line 12. Further, the source electrode and the drain electrode to be connected with the semiconductor layer of the TFT 14 are formed at the same time as the video signal line.

On the substrate 11 in which a plurality of electrodes are formed, the alignment layer 19 is formed by transfer method or the like. For example, an organic thin film such as a polyimide thin film, which is a polymeric material, may be used as the alignment layer 19. Then, the alignment layer 19 is heated to be cured, and alignment layer treatment (rubbing treatment) is performed to make micro grooves in one direction on the surface of the alignment layer 19 which is brought into contact with liquid crystal 30. The rubbing treatment is performed with the use of a roller which is wrapped with a nylon rubbing cloth or the like. By the above-described process, the protrusion 171a is formed on the separated pattern 131, and the array substrate 10 which includes the step portion 171 is produced.

On the other substrate 21, the light shielding layer 22 is formed by photolithography. As the light shielding layer 22, a resin containing pigment or a metal such as chromium may be used. Further, the colored layer 23 is formed by photolithography so as to fill the space between the light shielding layer 22. As the colored layer 23, a photosensitive resin containing pigment or dye may be used. Then, the counter electrode 24 is formed substantially all over the substrate 21 so as to cover the light shielding layer 22 and the colored layer 23. As the counter electrode 24, a transparent conductive film which is made of ITO or the like may be used.

On the counter electrode 24, a photoresist to serve as the columnar spacer 25 is deposited. The photoresist is patterned by known photolithography to thereby form the columnar spacer 25. The columnar spacer 25 is formed in the position that is opposite the step portion 171 of the array substrate 10 in the panel alignment step (panel attaching step) which is described later. On the counter substrate 20 in which the columnar spacer 25 is formed in this manner, the alignment layer 29 is formed, and rubbing treatment is performed thereon just like in the array substrate 10. By the above-described process, the counter substrate 20 which has the columnar spacer 25 is produced.

Next, the sealing material 34 is formed on either one of the array substrate 10 or the counter substrate 20. The frame-like sealing material 34 is formed on the periphery of the array substrate 10 or the counter substrate 20 except for a part to serve as a liquid crystal filling port. Then, the array substrate 10 and the counter substrate 20 are attached with each other by the sealing material 34 with the surfaces having the alignment layers 19 and 29 facing each other. In this step, the array substrate 10 and the counter substrate 20 are attached in such a way that the top face of the columnar spacer 25 is placed in the position which includes the protrusion 171a of the step portion 171. The columnar spacer 25 and the protrusion 171a of the step portion 171 are thereby placed opposite each other, so that the panel gap between the array substrate 10 and the counter substrate 20 is determined.

After that, liquid crystal 30 is filled into the space surrounded by the sealing material 34 between the array substrate 10 and the counter substrate 20. Specifically, liquid crystal filling port is soaked in liquid crystal 30, so that liquid crystal 30 is filled into the space which is surrounded by the array substrate 10, the counter substrate 20 and the sealing material 34 by capillarity (i.e. pumping or dipping method). Then, liquid crystal filling port is sealed by a sealant and then the sealant is cured, thereby tightly sealing liquid crystal 30 in the closed position. Besides the pumping method, liquid crystal 30 may sealed in the closed position which is surrounded by the array substrate 10, the counter substrate 20 and the sealing material 34 by being dropped therein (dropping or dispenser method).

Then, the polarizing plates 31 and 32 are adhered onto the outer surfaces of the array substrate 10 and the counter substrate 20, respectively. Then, the control board 35 is mounted, and a backlight unit or the like is placed. By the above-described process, the liquid crystal display apparatus according to this embodiment is fabricated.

As described above, in this embodiment, the step portion 171 is formed by placing the separated pattern 131 in the part which is opposite the columnar spacer 25. The step portion 171 has the height of 0.3 μm or smaller and the area of ½ or smaller the area of the top face of the columnar spacer 25. Further, the array substrate 10 and the counter substrate 20 are attached in such a way that the protrusion 171a of the step portion 171 is placed inside the top face of the columnar spacer 25. Thus, the protrusion 171a which maintains the panel gap in the normal state and the base 171b which contributes to maintain the panel gap when a strong external force is applied are placed opposite one columnar spacer 25. This structure eliminates the need for forming a thin columnar spacer with a diameter of 10 μm or smaller, thereby increasing the adhesion strength of the columnar spacer and prevents the columnar spacer from falling off. It is therefore possible to improve the display quality of the liquid crystal display apparatus. Further, the structure eliminates the need for increasing the number of columnar spaces, thereby suppressing a decrease in yield.

Under the low temperature environment, the part of the columnar spacer 25 which is opposite the protrusion 171a of the step portion 171 is elastically deformed. The gap thereby becomes narrower by following the reduction of the volume of liquid crystal 30, which prevents the low-temperature bubbling. When a strong external force is applied to the panel, in addition to the part of the columnar spacer 25 which is opposite the protrusion 171a, the part of the columnar spacer 25 which is opposite the base 171b contributes to maintain the gap. This suppresses a further change in the panel gap, thereby avoiding the display unevenness.

Because liquid crystal 30 is misaligned in the vicinity of the columnar spacer 25, light leakage occurs. In this embodiment, the columnar spacer 25 is disposed not to lie off the part above the scanning signal line 12. Thus, the step portion 171 and the separated pattern 131 are formed above the scanning signal line 12. The columnar spacer 25 is thereby placed in the area different from an opening which serves as a pixel, thus preventing the degradation of the display quality due to the light leakage.

### Second Embodiment

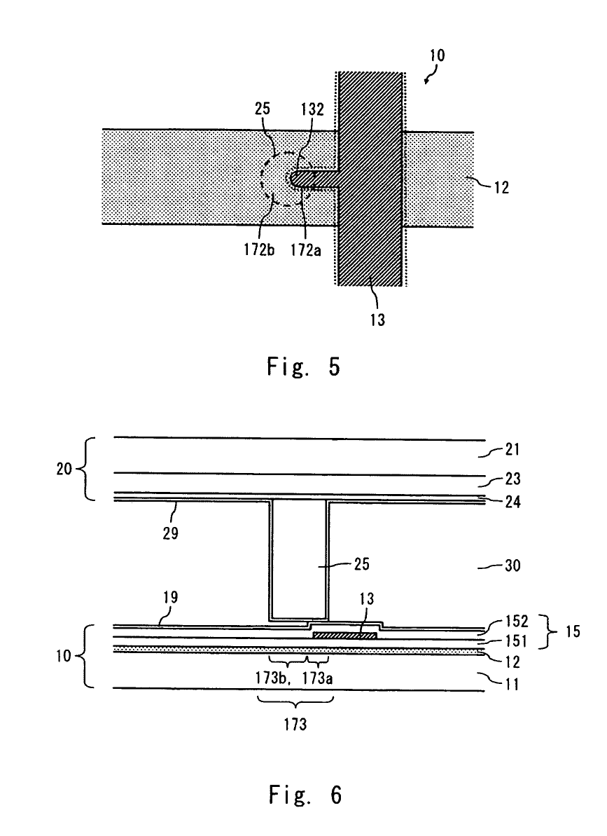

A liquid crystal display apparatus according to a second embodiment of the present invention is described hereinafter with reference to FIGS. 4 and 5. FIG. 4 is a schematic sectional view showing a columnar spacer and its vicinity according to the second embodiment in an enlarged scale. FIG. 5 is a top view schematically showing the array substrate 10 in FIG. 4. In FIG. 5, the outer shape of the columnar spacer which is placed on the counter substrate 20 is illustrated by a dotted line for convenience of description. This embodiment is different from the first embodiment in the position where the columnar spacer 25 is placed. The other structure is the same as that of the first embodiment and thus not repeatedly described below.

In FIGS. 4 and 5, the same elements as in FIGS. 1 to 3 are denoted by the same reference numerals, and differences are described below. Referring to FIG. 4, the scanning signal line 12 is disposed on the substrate 11 in the array substrate 10. The insulating layer 151 is disposed all over the substrate 11 so as to cover the scanning signal line 12. A video signal line 13 is disposed to intersect with the scanning signal line 12 with the insulating layer 151 interposed therebetween. In this embodiment, an extension pattern 132 which extends from the video signal line 13 is disposed above the scanning signal line 12. The extension pattern 132 extends from the intersection with the scanning signal line 12, and it has a substantially semicircular shape at its end. The shape of the extension pattern 132, however, is not limited thereto.

The extension pattern 132 extends from the video signal line 13 to the position opposite the columnar spacer 25. Specifically, referring to the top view of FIG. 5, the extension pattern 132 is placed to lie across the outer edge of the columnar spacer 25, and a part of the extension pattern 132 overlaps the columnar spacer 25. The area of the extension pattern 132 which overlaps the columnar spacer 25 is set within the range that a protrusion 172a of a step portion 172, which is described later, is ½ or smaller the area of the top face of the columnar spacer 25. The extension pattern 132 preferably extends from the video signal line 13 toward the position on the array substrate 10 which is opposite the center point of the top face of the columnar spacer 25.

On the extension pattern 132 and the video signal line 13, the insulating layer 152 is deposited all over the substrate 11. The alignment layer 19 is formed thereon. In this manner, above the extension pattern 132, the insulating layer 152 and the alignment layer 19 are placed to cover the extension pattern 132 and thereby form the step portion 172. The step portion 172 is composed of the protrusion 172a which is located above the extension pattern 132 and a base 172b which is located in the other area. Thus, in the part of the array substrate 10 which is opposite the columnar spacer 25, a total thickness of the array substrate 10 is larger in the protrusion 172a than in the base 172b, so that the protrusion 172a is highest in the part which is opposite the columnar spacer 25. The boundary between the protrusion 172a and the base 172b is a size larger than the extension pattern 132 as shown in FIG. 5. Therefore, a part of the columnar spacer 25 is opposite the protrusion 172a of the step portion 172 and thereby determines the panel gap between the array substrate 10 and the counter substrate 20. On the other hand, the part of the columnar spacer 25 which is opposite the base 172b of the step portion 172 does not maintain the panel gap between the array substrate 10 and the counter substrate 20.

In this embodiment, just like the first embodiment, the area of the protrusion 172a of the step portion 172 which overlaps the columnar spacer 25 is ½ or smaller the area of the top face of the columnar spacer 25. Accordingly, the area of the extension pattern 132 is set within the range that the protrusion 172a with the area ½ or smaller the area of the top face of the columnar spacer 25 is formed. The height of the step portion 172 which is placed in the part opposite the top face of the columnar spacer 25 is preferably larger than 0 μm and equal to or smaller than 0.3 μm. Thus, a difference in height between the protrusion 172a and the base 172b is 0.3 μm or smaller. In this example, the step portion 172 has a height of 0.25 μm as in the first embodiment.

In the method of manufacturing the liquid crystal display apparatus of the above-described structure, the extension pattern 132 is formed instead of the separated pattern 131 of the first embodiment to dispose the step portion 172 on the array substrate 10. Then, the array substrate 10 and the counter substrate 20 are attached in such a way that the protrusion 172a of the step portion 172 overlaps the columnar spacer 25 in the area that is ½ or smaller the area of the top face of the columnar spacer 25. The other steps are the same as those in the first embodiment and not repeatedly described below. In order to make the protrusion 172a and the columnar spacer 25 overlap in the area that is ½ or smaller the area of the top face of the columnar spacer 25, it is necessary to form the structure in consideration of the size of the extension pattern 132, the position of the columnar spacer 25 and so on.

As described above, in this embodiment, the step portion 172 with a height of 0.3 μm or smaller is formed in the part which is opposite the columnar spacer 25 by extending the extension pattern 132 from the video signal line 13. Then, the array substrate 10 and the counter substrate 20 are attached in such a way that the protrusion 172a of the step portion 172 overlaps the top face of the columnar spacer 25 in the area that is ½ or smaller the area thereof. Thus, the protrusion 172a which maintains the panel gap in the normal state and the base 172b which contributes to maintain the panel gap when a strong external force is applied are placed opposite one columnar spacer 25. The protrusion 172a is placed to across the outer edge of the columnar spacer 25. This structure eliminates the need for forming a thin columnar spacer, thereby increasing the adhesion strength of the columnar spacer and prevents the columnar spacer from falling off as in the first embodiment. It is therefore possible to improve the display quality of the liquid crystal display apparatus. Further, the structure eliminates the need for increasing the number of columnar spaces, thereby suppressing a decrease in yield.

Under the low temperature environment, the part of the columnar spacer 25 which is opposite the protrusion 172a of the step portion 172 is elastically deformed. The gap thereby becomes narrower by following the reduction of the volume of liquid crystal 30, which prevents the low-temperature bubbling. When a strong external force is applied to the panel, in addition to the part of the columnar spacer 25 which is opposite the protrusion 172a, the part of the columnar spacer 25 which is opposite the base 172b contributes to maintain the gap. This suppresses a further change in the panel gap, thereby avoiding the display unevenness.

### Third Embodiment

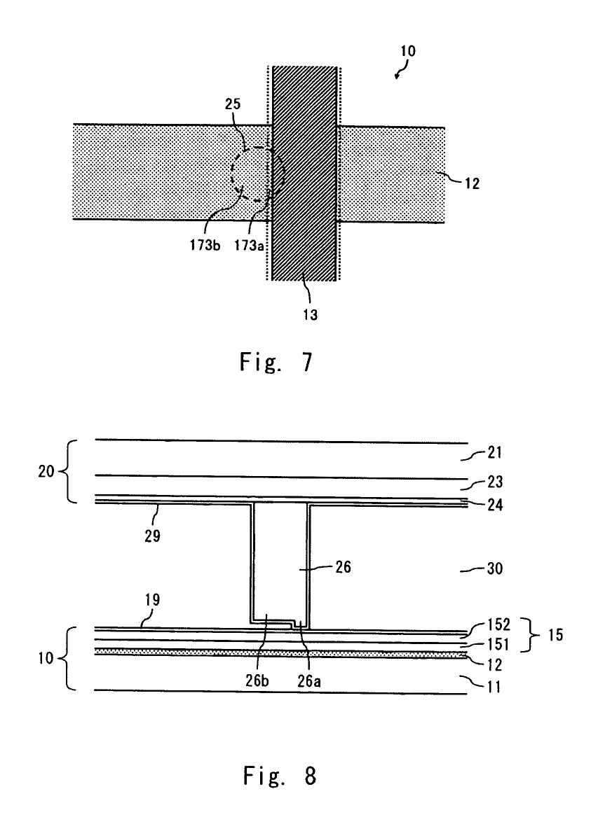

A liquid crystal display apparatus according to a third embodiment of the present invention is described hereinafter with reference to FIGS. 6 and 7. FIG. 6 is a schematic sectional view showing a columnar spacer and its vicinity according to the third embodiment in an enlarged scale. FIG. 7 is a top view schematically showing the array substrate 10 in FIG. 6. In FIG. 7, the outer shape of the columnar spacer which is placed on the counter substrate 20 is illustrated by a dotted line for convenience of description. This embodiment is different from the first and second embodiments in the position where the columnar spacer 25 is placed. The other structure is the same as that of the first embodiment and thus not repeatedly described below.

In FIGS. 6 and 7, the same elements as in FIGS. 1 to 3 are denoted by the same reference numerals, and differences are described below. Referring to FIG. 6, the scanning signal line 12 is disposed on the substrate 11 in the array substrate 10. The insulating layer 151 is disposed all over the substrate 11 so as to cover the scanning signal line 12. The video signal line 13 is disposed to intersect with the scanning signal line 12 with the insulating layer 151 interposed therebetween. In this embodiment, the video signal line 13 is placed opposite to a part of the columnar spacer 25 so as to overlap the part. Specifically, referring to the top view of FIG. 7, the columnar spacer 25 is placed to lie across the outer edge of the video signal line 13. In this embodiment, the separated pattern 131 and the extension pattern 132 are not placed. It is preferred that the columnar spacer 25 lies across the outer edge of the video signal line 13 at the intersection between the video signal line 13 and the scanning signal line 12 as shown in FIG. 7.

On the video signal line 13, the insulating layer 152 is deposited all over the substrate 11. The alignment layer 19 is disposed thereon. In this manner, above the video signal line 13, the insulating layer 152 and the alignment layer 19 are placed to cover the video signal line 13 and thereby form a step portion 173. The step portion 173 is composed of a protrusion 173a which is located above the video signal line 13 and a base 173b which is located in the other area. Thus, in the part of the array substrate 10 which is opposite the columnar spacer 25, a total thickness of the array substrate 10 is larger in the protrusion 173a than in the base 173b, so that the protrusion 173a is highest in the part which is opposite the columnar spacer 25. The boundary between the protrusion 173a and the base 173b is a size larger than the video signal line 13 as shown in FIG. 7. Therefore, a part of the columnar spacer 25 is opposite the protrusion 173a of the step portion 173 and thereby determines the panel gap between the array substrate 10 and the counter substrate 20. On the other hand, the part of the columnar spacer 25 which is opposite the base 173b of the step portion 173 does not maintain the panel gap between the array substrate 10 and the counter substrate 20.

In this embodiment, just like the first embodiment, the area of the protrusion 173a of the step portion 173 which overlaps the columnar spacer 25 is ½ or smaller the area of the top face of the columnar spacer 25. The height of the step portion 173 which is placed in the part opposite the top face of the columnar spacer 25 is preferably larger than 0 μm and equal to or smaller than 0.3 μm. Thus, a difference in height between the protrusion 173a and the base 173b is 0.3 μm or smaller. In this example, the step portion 173 has a height of 0.25 μm as in the first embodiment.

In the method of manufacturing the liquid crystal display apparatus of the above-described structure, the step portion 173 is formed on the array substrate 10 by the video signal line 13 without forming the separated pattern 131 of the first embodiment. Then, the array substrate 10 and the counter substrate 20 are attached in such a way that the protrusion 173a of the step portion 173 overlaps the columnar spacer 25 in the area that is ½ or smaller the area of the top face of the columnar spacer 25. The other steps are the same as those in the first embodiment and not repeatedly described below. In order to make the protrusion 173a and the columnar spacer 25 overlap in the area that is ½ or smaller the area of the top face of the columnar spacer 25, it is necessary to form the structure in consideration of the position of the columnar spacer 25, the size and the position of the video signal line 13 and so on.

As described above, in this embodiment, the step portion 173 with a height of 0.3 μm or smaller is formed in the part which is opposite the columnar spacer 25 by the video signal line 13. Then, the array substrate 10 and the counter substrate 20 are attached in such a way that the protrusion 173a of the step portion 173 overlaps the top face of the columnar spacer 25 in the area that is ½ or smaller the area thereof. Thus, the protrusion 173a which maintains the panel gap in the normal state and the base 173b which contributes to maintain the panel gap when a strong external force is applied are placed opposite one columnar spacer 25. The protrusion 173a is placed to across the outer edge of the columnar spacer 25. This structure eliminates the need for forming a thin columnar spacer, thereby increasing the adhesion strength of the columnar spacer and prevents the columnar spacer from falling off as in the first embodiment. It is therefore possible to improve the display quality of the liquid crystal display apparatus. Further, the structure eliminates the need for increasing the number of columnar spaces, thereby suppressing a decrease in yield.

Under the low temperature environment, the part of the columnar spacer 25 which is opposite the step portion 173 is elastically deformed. The gap thereby becomes narrower by following the reduction of the volume of liquid crystal 30, which prevents the low-temperature bubbling. When a strong external force is applied to the panel, in addition to the part of the columnar spacer 25 which is opposite the protrusion 173a, the part of the columnar spacer 25 which is opposite the base 173b contributes to maintain the gap. This suppresses a further change in the panel gap, thereby avoiding the display unevenness. Because liquid crystal 30 is misaligned due to the presence of the columnar spacer 25, the columnar spacer 25 is preferably placed opposite the step portion 173 above the scanning signal line 12, which is, the step portion 173 at the intersection between the scanning signal line 12 and the video signal line 13.

### Fourth Embodiment

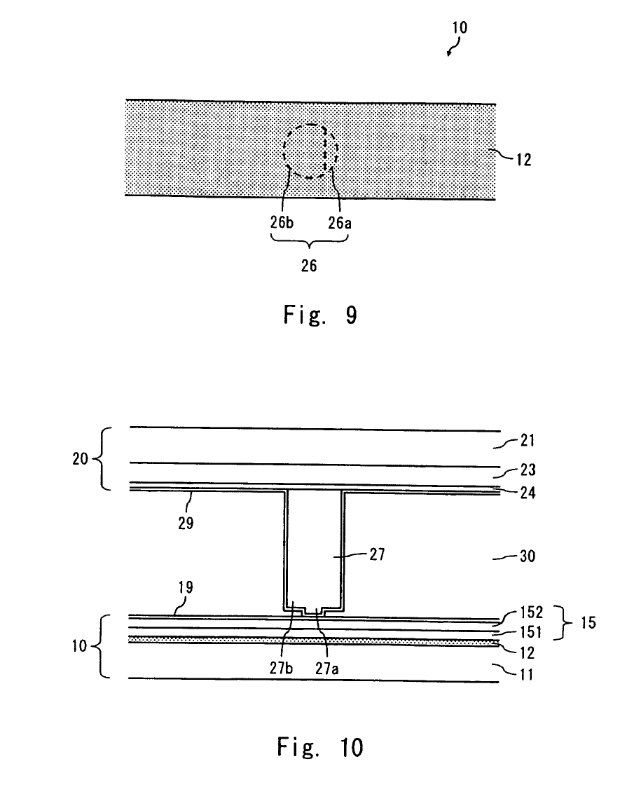

A liquid crystal display apparatus according to a fourth embodiment of the present invention is described hereinafter with reference to FIGS. 8 and 9. FIG. 8 is a schematic sectional view showing a columnar spacer and its vicinity according to the fourth embodiment in an enlarged scale. FIG. 9 is a top view schematically showing the array substrate 10 in FIG. 8. In FIG. 9, the outer shape of the columnar spacer which is placed on the counter substrate 20 is illustrated by a dotted line for convenience of description. This embodiment is different from the first to third embodiments in the shape and the position of the columnar spacer. The other structure is the same as that of the first embodiment and thus not repeatedly described below.

In FIGS. 8 and 9, the same elements as in FIGS. 1 to 3 are denoted by the same reference numerals, and differences are described below. Referring to FIG. 8, the scanning signal line 12 is disposed on the substrate 11 in the array substrate 10. The insulating layer 151 is disposed all over the substrate 11 so as to cover the scanning signal line 12. The video signal line is disposed in a portion which is not shown so as to intersect with the scanning signal line 12 with the insulating layer 151 interposed therebetween. On the video signal line, the insulating layer 152 is deposited all over the substrate 11. The alignment layer 19 is disposed thereon. In this embodiment, the separated pattern 131 and the extension pattern 132 are not placed. Thus, a step portion is not formed in the part above the scanning signal line 12 where a pattern formed by another layer is not placed, so that a total film thickness is substantially equal.

A columnar spacer 26 is formed on the counter substrate 20 in the part which is opposite the scanning signal line 12. Referring to the top view of FIG. 9, the columnar spacer 26 is placed inside the scanning signal line 12. In this embodiment, the columnar spacer 26 is composed of a protrusion 26a and a base 26b which is lower than the protrusion 26a. Referring to FIG. 9, the protrusion 26a is located in the right side part of the columnar spacer 26, and the base 26b is located in the other part. In this embodiment, the protrusion 26a is placed at the end of the columnar spacer 26. By the protrusion 26a, a step is formed on the top face of the columnar spacer 26. The cross section of the columnar spacer 26 is thereby step-like as shown in FIG. 8, and the protrusion 26a is highest on the top face of the columnar spacer 26. In order to avoid the low-temperature bubbling, the top face of the protrusion 26a of the columnar spacer 26 has the area which is equal to or smaller than the area of the top face of the base 26b. Thus, the area of the top face of the protrusion 26a is ½ or smaller the area of the top face of the columnar spacer 26. Further, in order to avoid the display unevenness, the height of the step between the protrusion 26a and the base 26b is preferably larger than 0 μm and equal to or smaller than 0.3 μm. Thus, a difference in height between the protrusion 26a and the base 26b is 0.3 μm or smaller. In this example, the columnar spacer 26 has the step with a height of 0.2 μm.

Therefore, the protrusion 26a of the columnar spacer 26 is opposite the array substrate 10 and thereby determines the panel gap between the array substrate 10 and the counter substrate 20. On the other hand, the base 26b of the columnar spacer 26 does not maintain the panel gap between the array substrate 10 and the counter substrate 20. When an external force is applied to the panel, the protrusion 26a of the columnar spacer 26 is elastically deformed and the panel gap is narrowed. If an external force which is applied to the panel becomes stronger, the space between the counter substrate 20 and the array substrate 10 which is formed at the base 26b becomes gradually narrower. When an external force which is strong enough to eliminate the space is applied, the base 26b of the columnar spacer 26 contributes to maintain the gap. The gap is thereby maintained by substantially the entire top face of the columnar spacer 26, which prevents a further change in panel gap.

In the method of manufacturing the liquid crystal display apparatus of the above-described structure, the columnar spacer 26 is formed using multi-tone exposure. Specifically, a photoresist to serve as the columnar spacer 26 is coated on the counter electrode 24 of the counter substrate 20. The multi-tone exposure is performed on the photoresist with the use of a photomask which includes an exposure portion, an intermediate exposure portion and a light shielding portion. The intermediate exposure portion is placed in the part of the photomask to form the base 26b of the columnar spacer 26. A half-tone mask, a gray-tone mask or the like is known as such a photomask. In the intermediate exposure portion of a half-tone mask, a semitransparent film which reduces the amount of transmitting light in the wavelength range that is used for exposure (typically, 350 to 450 nm) is placed. In the intermediate exposure portion of a gray-tone mask, a slit pattern which is equal to or lower than the resolution of an exposure system is formed in order to reduce the exposure amount utilizing optical diffraction.

After performing the exposure with the use of such a photomask, development is performed. The protrusion 26a and the base 26b are thereby patterned at the same time, and the columnar spacer 26 having a step is formed. Alternatively, the columnar spacer 26 may be formed by performing exposure twice with the use of two photomasks rather than using the multi-tone exposure. In this embodiment, the separated pattern 131 of the first embodiment is not formed on the array substrate 10. Then, the array substrate 10 and the counter substrate 20 are attached in such a way that the columnar spacer 26 is located within the area above the scanning signal line 12 where a pattern that is formed by another layer is not placed. The other steps are the same as those of the first embodiment and thus not repeatedly described below.

As described above, in this embodiment, the columnar spacer 26 which has the protrusion 26a and the base 26b is formed. A difference in height between the protrusion 26a the base 26b is 0.3 μm or smaller, and the protrusion 26a occupies the area that is ½ or smaller the area of the top face of the columnar spacer 26. Then, the array substrate 10 and the counter substrate 20 are attached in such a way that the columnar spacer 26 is located within the area above the scanning signal line 12 where a pattern that is formed by another layer is not placed. Thus, the protrusion 26a which maintains the panel gap in the normal state and the base 26b which contributes to maintain the panel gap when a strong external force is applied are included in one columnar spacer 26. This structure eliminates the need for forming a thin columnar spacer, thereby increasing the adhesion strength of the columnar spacer and prevents the columnar spacer from falling off as in the first embodiment. It is therefore possible to improve the display quality of the liquid crystal display apparatus. Further, the structure eliminates the need for increasing the number of columnar spaces, thereby suppressing a decrease in yield.

Under the low temperature environment, the protrusion 26a of the columnar spacer 26 is elastically deformed. The gap thereby becomes narrower by following the reduction of the volume of liquid crystal 30, which prevents the low-temperature bubbling. When a strong external force is applied to the panel, in addition to the protrusion 26a, the base 26b of the columnar spacer 26 contributes to maintain the gap. This suppresses a further change in the panel gap, thereby avoiding the display unevenness.

### Fifth Embodiment

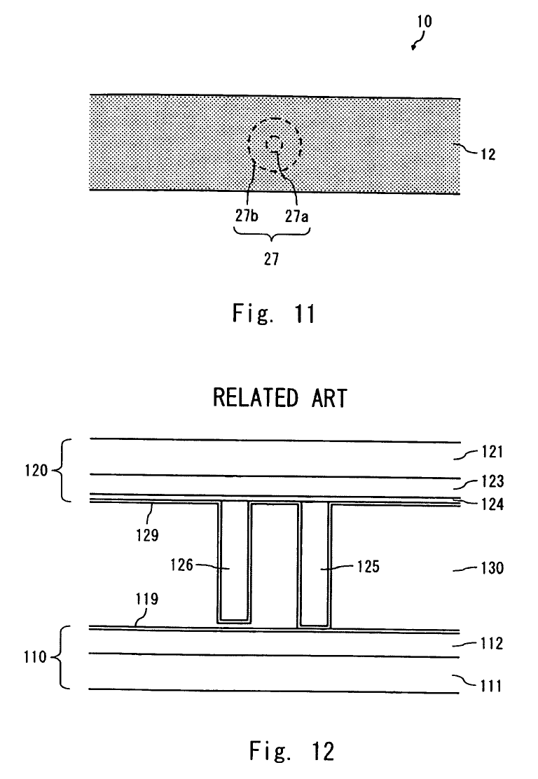

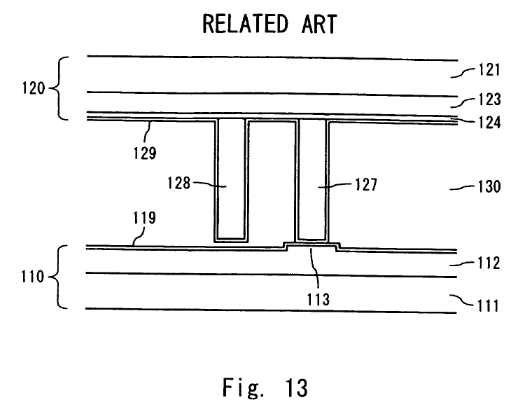

A liquid crystal display apparatus according to a fifth embodiment of the present invention is described hereinafter with reference to FIGS. 10 and 11. FIG. 10 is a schematic sectional view showing a columnar spacer and its vicinity according to the fifth embodiment in an enlarged scale. FIG. 11 is a top view schematically showing the array substrate 10 in FIG. 10. In FIG. 11, the outer shape of the columnar spacer which is placed on the counter substrate 20 is illustrated by a dotted line for convenience of description. This embodiment is different from the fourth embodiment in the shape of the columnar spacer. The other structure is the same as that of the fourth embodiment and thus not repeatedly described below.

In FIGS. 10 and 11, the same elements as in FIGS. 8 and 9 are denoted by the same reference numerals, and differences are described below. Just like the fourth embodiment, a columnar spacer 27 is formed on the counter substrate 20 in the part which is opposite the scanning signal line 12. The columnar spacer 27 is composed of a protrusion 27a and a base 27b which is lower than the protrusion 27a. In this embodiment, the protrusion 27a is located substantially at the center of the columnar spacer 27 as shown in FIG. 11. The base 27b is located in the surrounding area of the protrusion 27a, which is, on the periphery of the columnar spacer 27. By the protrusion 27a, a step is formed on the top face of the columnar spacer 27. The cross section of the columnar spacer 27 is thereby step-like as shown in FIG. 10, and the protrusion 27a is highest on the top face of the columnar spacer 27. In order to avoid the low-temperature bubbling, the top face of the protrusion 27a of the columnar spacer 27 has the area which is equal to or smaller than the area of the top face of the base 27b. Thus, the area of the top face of the protrusion 27a is ½ or smaller the area of the top face of the columnar spacer 27. Further, in order to avoid the display unevenness, a difference in film thickness between the protrusion 27a and the base 27b is preferably larger than 0 μm and equal to or smaller than 0.3 μm. Thus, a difference in height between the protrusion 27a and the base 27b is 0.3 μm or smaller. In this example, the columnar spacer 27 has the step with a height of 0.2 μm.

In the method of manufacturing the liquid crystal display apparatus of the above-described structure, the columnar spacer 27 is formed using the multi-tone exposure as in the fourth embodiment. The protrusion 27a and the base 27b are thereby patterned at the same time, and the columnar spacer 27 having a step is formed.

As described above, in this embodiment, the columnar spacer 27 which has the protrusion 27a and the base 27b is formed. A difference in height between the protrusion 27a the base 27b is 0.3 μm or smaller, and the protrusion 27a occupies the area that is ½ or smaller the area of the top face of the columnar spacer 27. Then, the array substrate 10 and the counter substrate 20 are attached in such a way that the columnar spacer 27 is located within the area above the scanning signal line 12 where a pattern that is formed by another layer is not placed. Thus, the protrusion 27a which maintains the panel gap in the normal state and the base 27b which contributes to maintain the panel gap when a strong external force is applied are included in one columnar spacer 27. This structure eliminates the need for forming a thin columnar spacer, thereby increasing the adhesion strength of the columnar spacer and prevents the columnar spacer from falling off as in the fourth embodiment. It is therefore possible to improve the display quality of the liquid crystal display apparatus. Further, the structure eliminates the need for increasing the number of columnar spaces, thereby suppressing a decrease in yield.

Under the low temperature environment, the protrusion 27a of the columnar spacer 27 is elastically deformed. The gap thereby becomes narrower by following the reduction of the volume of the liquid crystal 30, which prevents the low-temperature bubbling. When a strong external force is applied to the panel, in addition to the protrusion 27a, the base 27b of the columnar spacer 27 contributes to maintain the gap. This suppresses a further change in the panel gap, thereby avoiding the display unevenness.

Although the case of placing the columnar spacer above the colored layer 23 with the counter electrode 24 interposed therebetween is described by way of illustration in the above-described first to fifth embodiments, the columnar spacer maybe placed on the light shielding layer 22. Further, although the columnar spacer is placed on the counter substrate 20 in the area which is opposite the scanning signal line 12, the present invention is not limited thereto. Although the case of forming the step portion by the video signal line 13 or by the pattern in the same layer as the video signal line 13 is described in the first to third embodiments, the step portion may be formed by the pattern in the layer of the scanning signal line 12, the semiconductor layer or the like which constitutes the array substrate 10 instead of the video signal line 13. The order of stacking the thin films which are formed on the array substrate 10, such as the scanning signal line 12, the video signal line 13 and the semiconductor layer, is also not limited in any way.

The columnar spacer may be placed on the array substrate 10 rather than on the counter substrate 20. In this case, the step portion is formed by the layer which constitutes the counter substrate 20. The pattern which is placed to form the step portion is not limited to a single layer, and a plurality of layers of pattern may be used to form the step portion. The shape of such a pattern is not limited as long as it forms the step portion. The side surface of the protrusion which forms the step portion may be tapered. Likewise, the shape of the protrusion to be formed on the top face of the columnar spacer is not limited. The side surface of the protrusion may be tapered.

Although the case of forming one protrusion in the step portion of the array substrate is described in the first to third embodiments, a plurality of protrusions may be formed. In this case, the area which is occupied by the highest level of the plurality of protrusions (levels) is ½ or smaller the area of the top face of the columnar spacer and the height from the base is 0.3 μm or smaller. The base is the level which is adjacent to the highest level in the area that is opposite the columnar spacer. Preferably, the base is the lowest level in the area that is opposite the columnar spacer. Likewise, a plurality of protrusions may be formed in the columnar spacer in the fourth and fifth embodiments. In this case, the area which is occupied by the highest level of the plurality of protrusions (levels) is ½ or smaller the area of the top face of the columnar spacer and the height from the base is 0.3 μm or smaller.

Although preferred embodiments of the present invention are explained in the foregoing, the present invention is not restricted to the above-mentioned embodiments. It will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A display apparatus comprising:
a first substrate;
a second substrate placed opposite the first substrate;
a display material placed between the first substrate and the second substrate;
a columnar spacer placed above a surface of the first substrate facing the second substrate to maintain a gap between the first substrate and the second substrate; and
a step portion placed above a part of the second substrate opposite the columnar spacer or on a top face of the columnar spacer with a height of 0.3 μm or smaller with a proportion of a highest level of the step portion to the top face of the columnar spacer being ½ or smaller.

2. The display apparatus according to claim 1, wherein
the step portion is formed above the second substrate by a pattern of at least one layer constituting the second substrate.

3. The display apparatus according to claim 2, wherein
the second substrate is an array substrate including a scanning signal line and a video signal line intersecting with the scanning signal line with an insulating layer interposed therebetween, and
the step portion is formed by a separated pattern separated from at least one of the scanning signal line, the video signal line and a semiconductor layer.

4. The display apparatus according to claim 2, wherein
the second substrate is an array substrate including a scanning signal line and a video signal line intersecting with the scanning signal line with an insulating layer interposed therebetween, and
the step portion is formed by an extension pattern extending from at least one of the scanning signal line, the video signal line and a semiconductor layer.

5. The display apparatus according to claim 2, wherein
the second substrate is an array substrate including a scanning signal line and a video signal line intersecting with the scanning signal line with an insulating layer interposed therebetween, and
the step portion is formed by an intersection between the scanning signal line and the video signal line.

6. The display apparatus according to claim 1, wherein
the step portion is formed by a protrusion placed on the top face of the columnar spacer.

7. The display apparatus according to claim 6, wherein
the protrusion is placed at the end of the columnar spacer.

8. The display apparatus according to claim 6, wherein
the protrusion is located at the center of the columnar spacer.

9. A method of manufacturing a display apparatus including a display material placed between a first substrate and a second substrate, comprising:
forming a columnar spacer above the first substrate;
forming a step portion with a height of 0.3 μm or smaller by forming a plurality of thin films above the second substrate; and
attaching the first substrate and the second substrate through a sealing material by placing a surface of the first substrate having the columnar spacer and a surface of the second substrate having the step portion opposite each other with a proportion of a highest level of the step portion to a top face of the columnar spacer being ½ or smaller.

10. The method of manufacturing a display apparatus according to claim 9, wherein
the step portion is formed by a pattern of at least one layer constituting the second substrate.

11. The method of manufacturing a display apparatus according to claim 10, wherein
the second substrate is an array substrate including a scanning signal line and a video signal line intersecting with the scanning signal line with an insulating layer interposed therebetween, and
the step portion is formed by a separated pattern separated from at least one of the scanning signal line, the video signal line and a semiconductor layer.

12. The method of manufacturing a display apparatus according to claim 10, wherein
the second substrate is an array substrate including a scanning signal line and a video signal line intersecting with the scanning signal line with an insulating layer interposed therebetween, and
the step portion is formed by an extension pattern extending from at least one of the scanning signal line, the video signal line and a semiconductor layer.

13. The method of manufacturing a display apparatus according to claim 10, wherein
the second substrate is an array substrate including a scanning signal line and a video signal line intersecting with the scanning signal line with an insulating layer interposed therebetween, and
the step portion is formed by an intersection between the scanning signal line and the video signal line.

14. A method of manufacturing a display apparatus including a display material placed between a first substrate and a second substrate, comprising:
forming a columnar spacer having a protrusion with a height of 0.3 μm or smaller above the first substrate with a proportion of the protrusion to a top face of the columnar spacer being ½ or smaller; and
attaching the first substrate and the second substrate through a sealing material by placing the second substrate opposite a surface of the first substrate having the columnar spacer.

15. The method of manufacturing a display apparatus according to claim 14, wherein
the columnar spacer having the protrusion is formed by multi-tone exposure.

16. The method of manufacturing a display apparatus according to claim 14, wherein
the protrusion is formed at the end of the columnar spacer.

17. The method of manufacturing a display apparatus according to claim 14, wherein
the protrusion is formed at the center of the columnar spacer.
